(19) United States
(12) Patent Application Publication
(10) Pub. No.: US 2008/0121189 A1
(43) Pub. Date: May 29, 2008

(54) ANIMAL FOOT TREATMENT SYSTEM

(75) Inventor: John S. Greeson, Roswell, NM (US)

Correspondence Address: LAW OFFICE OF RAY R. REGAN, P.A., P.O. BOX 1442, CORRALES, NM, 87048, US

(73) Assignee: Dairy Solutions, Inc., a New Mexico corporation, Roswell, NM (US)

(21) Appl. No.: 11/458,935

(22) Filed: Jul. 20, 2006

(51) Int. Cl. A01K 13/00; A01K 29/00

(52) U.S. Cl. 119/666

(57) ABSTRACT

This abstract is provided to allow determination of the subject matter of the disclosure but not for interpretation or meaning of any claim. The specification and drawing figures described and show an animal foot treatment system that includes one or more mats. The mats include pressure-sensing plates. On application of foot pressure to the pressure sensing plates, and/or on removal of foot pressure from the pressure sensing plates, the pressure sensing plates send one or more signals to a processor. The processor causes an array of dispensers to discharge ingredients for treatment of animal foot problems on the foot that as either been applied to the mats or lifted from the mats. A tank is provided for holding the ingredients. A pump conveys the ingredients from the tank to the array of dispensers. A mat-flushing device also is included for removal of debris from the animal foot treatment system.

### FIELD OF TECHNOLOGY

The animal foot treatment system disclosed and claimed in this document pertains generally to the field of discharging ingredients on the feet of animals for treatment of diseases, infections and injuries to a foot of an animal, as well preventative ingredients for promoting resistance to diseases and lacerations, for hardening hooves, and other desirable treatments. More particularly, the new and useful animal foot treatment system disclosed and claimed in this document provides an animal foot treatment system useful in treating the feet of cattle.

### BACKGROUND

Control and management of insects and other pests on domesticated animals has proven challenging, costly, often elusive, and frequently ineffective. Dealing with pests of the kind described in the U.S. Patent Application filed by the inventor named in this document, U.S. patent application Ser. No. 10/903,318 filed on Jul. 30, 2004, is an important objective for dairy herdsmen. The pests dramatically impact the economics of animal production and milk production, a commercial industry constituting a significant contribution to the gross national product of the United States. The diary cattle industry, for example, is estimated to produce $12 billion annually. Failure to deal with pests causes a number of problems, including irritating cows so severely that milk production suffers; disease pathogens are transmitted; intestinal diseases among humans associated with cow herds are possible; and a variety of regulatory rules and regulations may be violated by failure to treat such pests. Exemplary solutions for solving problem arising from pests among dairy herds have been provided by the inventor named in this document as shown in U.S. Pat. No. 6,230,660 issued May 15, 2001; U.S. Pat. No. 6,6651,589 issued Nov. 525,2003; U.S. patent application Ser. No. 09/844,316 filed Apr. 26, 2001; U.S. Pat. No. 6,779,489 issued Aug. 24, 2004; and application Ser. No. 10/903,318 filed Jul. 30. 2004 (collectively, “Prior Applications and Patents”).

In addition to the problems solved by the Prior Applications and Patents, a wide range of diseases, infections and injuries to their feet may affect animals and mammals, including cattle that are part of diary herds. In addition to treating diseases, infections and injuries to the feet of cattle, for example, it is useful to apply various ingredients for preventative treatment to achieve resistance to diseases and lacerations, to harden hooves, and to achieve similar and related objectives.

Livestock in a diary heard, for example, are subject to forming a variety of warts, sole ulcers, foot rot, heel cracks and variations of lesions and infections on their feet, all of which may individually or collectively cause livestock to suffer lameness, clubbed hooves, loss of body weight, decreased production, and decrease fertility (collectively, “animal foot problems”).

None of the currently available suggestions for treating problems associated with animals feet has proven effective. The most common way to apply topical solutions to hooves of animals is a form of footbath, or tub, through which the animal moves. Concentrations in footbaths of ingredients combined to chemically treat animal foot problems are often rendered ineffective because of the debris deposited in the ingredients in the form of animal waste by livestock passing through the footbath. Accordingly, until now, maintaining precise concentrations of the ingredients has proven impossible.

A need exists in the industry for a new, useful animal foot treatment system that is capable of applying precise amounts of ingredients at precise times for precise lengths of time on animal feet to treat the wide varieties of animal foot problems.

### SUMMARY

The animal foot treatment system described and claimed in this document includes one or more mats. Each mat contains pressure-sensing plates. The pressure sensing plates are capable of generating signals that are conveyed to a processor operatively connected to the pressure-sensing plates. The processor also is operatively connected to an array of dispensers mounted on the mats. Some signals are generated on application of an animal's foot to a mat; other signals are generated on removal of an animal foot from a mat. In combination, the pressure-sensing plates generate signals that are directed to the processor. The processor, in turn, causes the array of dispensers to both dispense and not dispense ingredients on an animal'foot or feet. As a foot is placed on a mat, or removed from a mat, and a signal consequently is generated, the processor causes the array of dispensers to discharge ingredients on the foot of the animal that has applied pressure on the mat, or has removed a foot and thus released the pressure-sensing plates. The processor is programmable to withhold a discharge for a desired period of time, and to discharge after a desired period of time for a desired period of time.

The dispensers are constructed to deliver a focused stream of ingredients to each foot in response to the signals. In addition, the array of dispenses discharges ingredients in focused streams of ingredients in precise amounts during precise time periods selected by an operator of the animal foot treatment system. A tank is provided to hold ingredients to be discharged through the dispensers. The tank is in fluid communication with the array of dispensers. In addition, a pump is provided for conveying ingredients from the tank through the array of dispensers. A mat-flushing device also is included to remove debris from the foot treatment system during operation.

It will become apparent to one skilled in the art that the claimed subject matter as a whole, including the structure of the apparatus, and the cooperation of the elements of the apparatus, combine to result in a number of unexpected advantages and utilities. The structure and co-operation of structure of the animal foot treatment system will become apparent to those skilled in the art when read in conjunction with the following description, drawing figures, and appended claims.

The foregoing has outlined broadly the more important features of the invention to better understand the detailed description that follows, and to better understand the contributions to the art. The animal foot treatment system is not limited in application, however, to the details of construction, and to the arrangements of the components, provided in the following description or drawing figures, but is capable of other embodiments, and of being practiced and carried out in various ways. Accordingly, the phraseology and terminology employed in this disclosure are for purpose of description and therefore should not be regarded as limiting. As those skilled in the art will appreciated, the conception on which this disclosure is based readily may be used as a basis for designing other structures, methods, and systems. The claims, therefore, include equivalent constructions.

Further, the abstract associated with this disclosure is intended neither to define the animal foot treatment system, which is measured by the claims, nor intended to limit the scope of the claims. The novel features of the animal foot treatment system are best understood from the accompanying drawing, considered in connection with the accompanying description of the drawing, in which similar reference characters refer to similar parts, and in which:

### BRIEF DESCRIPTION OF THE DRAWING

FIG. 1A of the drawing is a perspective view of a portion of the foot treatment system in an operative environment with a cow moving across the pads and array of sprayer of the system;

FIG. 1B is an expanded view of 1B in FIG. 1A showing a dispenser in operation;

FIG. 2A is a perspective view of a pad as disclosed and claimed in this document;

FIG. 2B is a cross-section view of the mat along the line 1-1 in FIG. 2A showing one embodiment of the pressure sensing plates;

FIG. 2C is a cross-section of one embodiment of the pressure sensing plates after contact is made between the plates by application of foot pressure to the mat;

FIG. 2D is a cross-section view of the mat showing another embodiment of the pressure-sensing plates;

FIG. 2E is a cross-section view of the mat showing another embodiment of the pressure-sensing plates as shown in FIG. 2D after contact is made between the plates by application of foot pressure to the mat.

FIG. 3 is an exploded perspective view of selected components of the animal foot treatment system; and

FIG. 4 also is a side view of the mats and the platform of the animal foot treatment system.

In the drawing figures and in the description, to the extend that the numerical designations in the drawing figures include lower case letters such as “a,b” such designations include multiple references, and the letter “n” in lower case such as “a-n” is intended to express a number of repetitions of the element designated by that numerical reference and subscripts.

### DETAILED DESCRIPTION

### Definitions

The term “foot” as used in this document means not only the terminal part of a vertebrate animal's leg, but also the hoof (the curved covering of horn that protects the front of the terminal part), the pad, the pastern, the dewclaw, the hock, the portion of the leg below the knee or hock on an animal such as a domestic bovine.

The term “debris” as used in this document means at least animal waste.

The term “ingredients” as used in this document means any combination of active and inert chemicals and fluids, including water, discharged from the array of dispensers for treating animal foot problems including, without limitations, diseases, infections, abrasions, and injuries to a foot of an animal, as well preventative ingredients including for example, those useful for creating resistance to diseases and lacerations, for hardening hooves, and similar desirable treatments. Thus, for example, the ingredients may include buffered sulfuric acid, copper sulfate, soap surfactants, marking colored dies to confirm application of treatment on a foot, and water, among others that are used to treat animal foot problems.

The term “processor” as used in this document includes but is not limited to a microprocessor (such as an integrated circuit containing a central processing unit of a computer on one or more chips, such that only the memory and input-output functionalities need be added), but also includes any device that may be programmed or used to conduct a sequence of operations leading to discharge of ingredients from dispensers. The term “processor,” therefore may include a controller, digital signal processor, and other equivalent devices.

The term “signal” as used in this document includes but is not limited to a detectable physical quantity, pulse or impulse, such as a voltage, current, or magnetic field strength, as well as mechanical means for activation.

The term “active” as used in this document includes but is not limited to discharging one or more focused streams of ingredients during one or more desired time intervals, and includes the suspension or delay in discharging ingredients during one or more other desired time intervals.

The term “focused” as used in the term “focused stream of ingredients” means a stream of ingredients discharged from the array of dispensers other than in a wide fan pattern.

The term “animal” as used in this document includes cattle, and thus both cows and steers, as well as other animals and mammals.

### DESCRIPTION

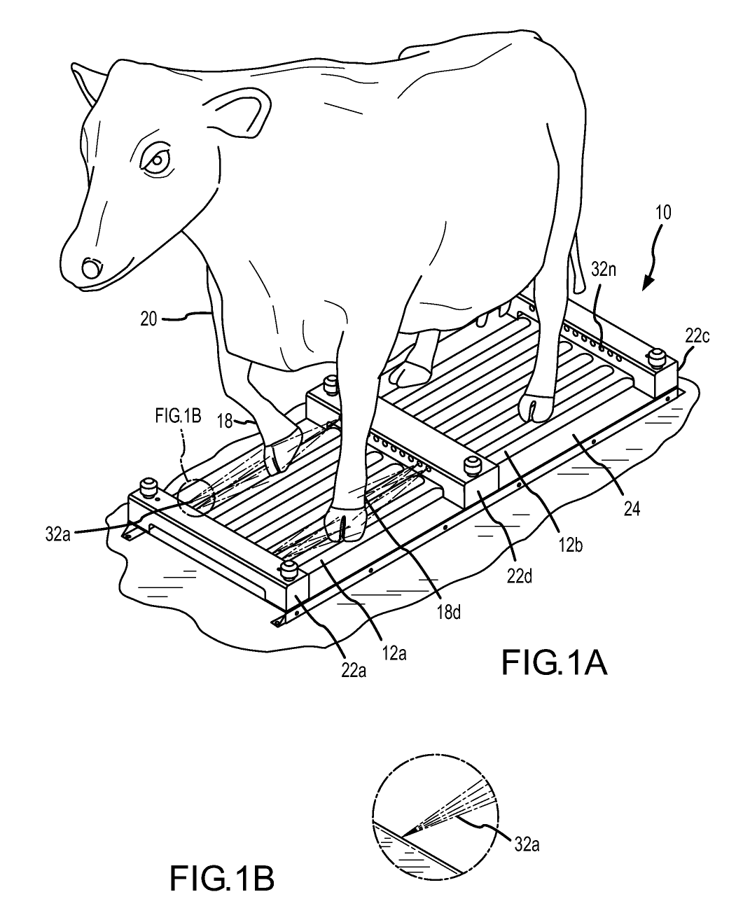

As shown in FIGS. 1-4, an animal foot treatment system is provided that in its broadest context includes at least one mat. Each mat includes pressure-sensing plates capable of generating and sending signals to activate dispensers that discharge treatment ingredients on a foot when a foot either has applied pressure on the mat, or has been lifted from the mat. The dispensers and pressure sensing plates are operatively connected together to cause the dispensers to discharge the ingredients. The dispensers and pressure sending plates also are operatively connected to a processor. The processor has the capability of processing signals from the pressure sensing plates in the mat to cause the dispensers to discharge a stream of ingredients in precise amounts during precise time periods. A tank for holding the ingredients also is provides, as well as a pump for delivering the ingredients through the system. A mat-flushing device also is included.

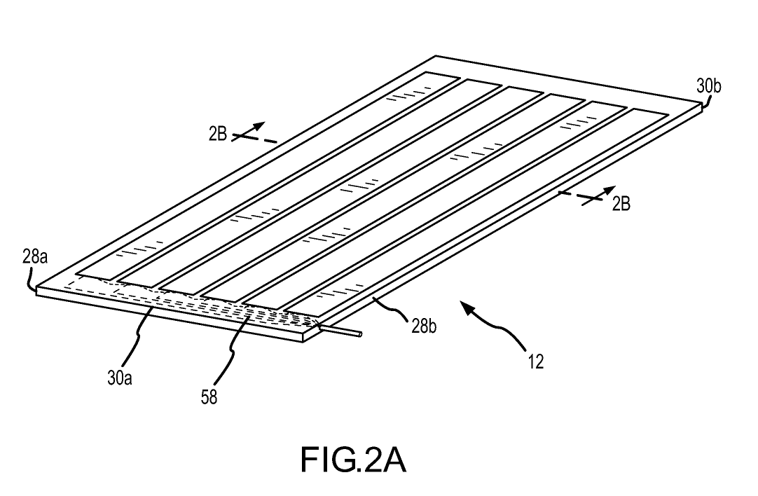

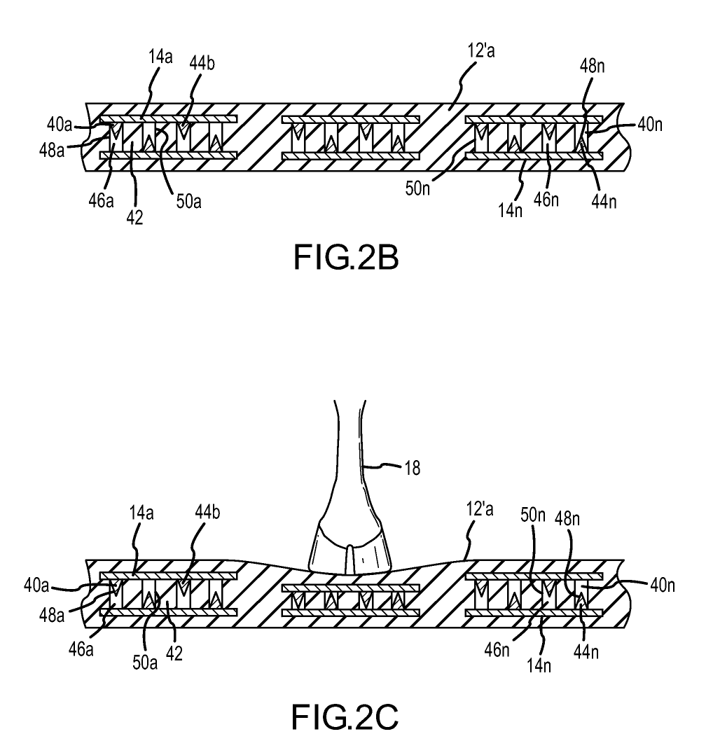

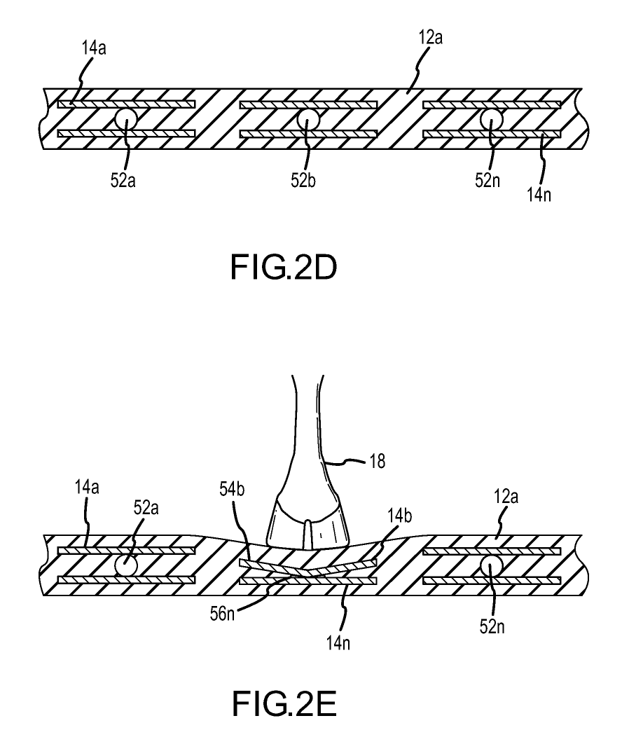

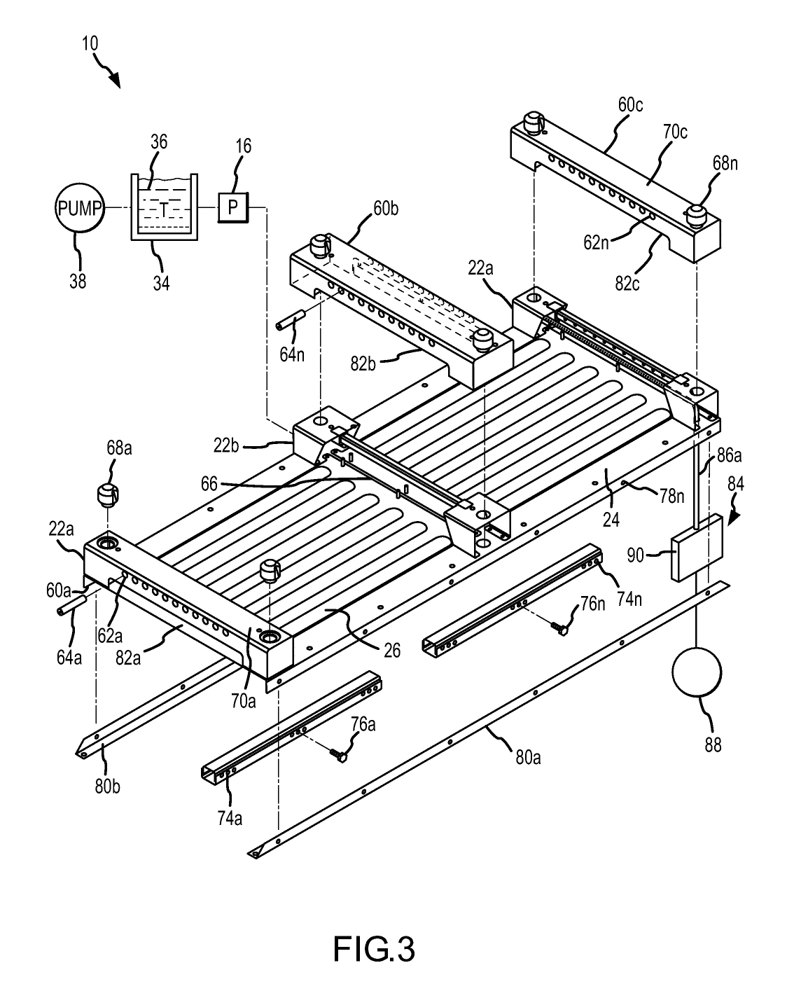

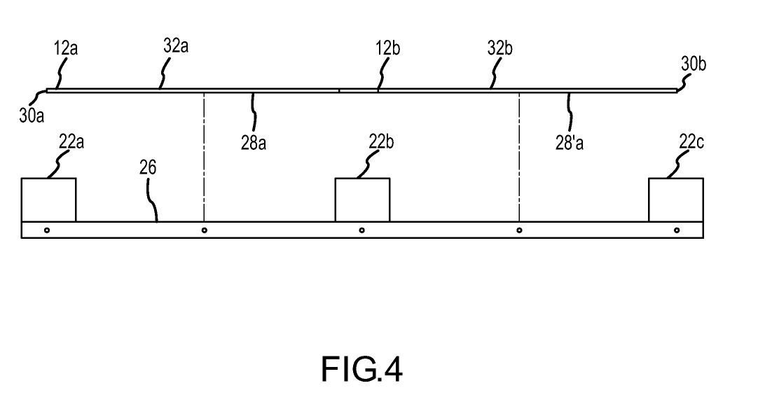

More specifically, as shown by cross-reference between FIGS. 1-4, an animal foot treatment system 10 is provided. Animal foot treatment system 10 includes one or more mats 12a,b. In the embodiment shown in FIGS. 1-2E and 4, the one or more mats 12a,b are compressively resilient mats 12a,b. In the embodiments illustrated in FIGS. 2A-2E, the compressibly resilient material is PVC, but the material is not a limitation of the animal foot treatment system 10. In the embodiments shown by cross-reference between FIGS. 1-2E, the mats 12a,b include a plurality of pressure sensing plates 14a-n as best shown in FIGS. 1-2E and 4. In the embodiments illustrated in FIGS. 1-2E, the one or more mats 12a,b surroundingly contains the plurality of pressure sensing plates 14a-n. Each of the plurality of pressure sensing plates 14a-n is adapted to generate and send to a processor 16 one or more signals as shown in FIG. 3. The one or more signals are generated and sent by application of a foot 18 of an animal 20 to a mat 12a,b. In addition, one or more signals are generated and sent to processor 16 on removal of a foot 18 from the one or more mats 12a-b. At least one reason for providing one or more mats 12a,b instead of a single mat 12 as shown in FIG. 4, is to allow an operator of animal foot treatment system 10 to remove a possible damaged mat 12a while continuing to operate animal foot treatment system 10 using the other mat 12b.

As shown diagrammatically in FIG. 3, animal foot treatment system 10 also includes processor 16. The processor 16 also is designated “P” and is operatively connected to the plurality of pressure sensing plates 14a-n in the one or more mats 12a,b. As also shown by cross-reference between FIGS. 1 and 3-4, the animal foot treatment system 10 also includes an array of dispensers 22a-c. The array of dispensers 22a-c is operatively connected to the plurality of pressure sensing plates 14a-n. The array of dispensers 22a-c also is operatively connected to the processor 16. In the embodiments shown by cross-reference between FIGS. 1 and 3-4, the array of dispensers 22a-c is mounted laterally across the one or more mats 12a,b, and the one or more mats 12a,b are mounted on a platform 24 best shown in FIG. 3. Thus, in the embodiment shown by cross-reference between FIGS. 3 and 4, the one or more mats 12a,b are mounted on the top surface 26 of platform 24. As also shown by cross-reference between FIGS. 2 and 4, the one or more mats 12a,b is formed with opposing sides 28a,b and opposing ends 30a,b. The array of dispensers 22a-c are mounted on the upper surface 32 of the one or more mats 12a,b laterally between the opposing sides 28a,b. The array of dispensers 22a-c is adapted to deliver to a foot 18 a focused stream of ingredients 32a as shown perhaps best in FIG. 1B. Further, the processor 16 is adapted to receive and process one or more signals from the one or more mats 12a,b and to thereby cause the array of dispensers 22a,c to discharge the focused stream of ingredients 32a-n in precise amounts during precise time periods.

In the embodiment illustrated in FIG. 3, the animal foot treatment system 10 also includes a tank 34 shown diagrammatically by the symbol “T” for holding ingredients 36 to be discharged on the foot 18 of an animal 20 from the array of dispensers 22a-c. The tank 34 is adapted to contain ingredients 36 in fluid communication with the array of dispensers 22a-c. In addition, a pump 38 is provided for conveying the ingredients 36 from the tank 34 to the array of dispensers 22a-c. The pump 38 also may mix the ingredients 36 in desired ratios for application through the animal foot treatment system 10 onto the foot 18 of an animal 20.

As further shown by cross-reference between FIGS. 2A-2D, the pressure-sensing plates 14a-n are surroundingly contained within the one or more mats 12a,b. In the embodiment illustrated by cross-reference between FIGS. 2B-2C, opposing pressure-sensing plates 14a-n include a plurality of electrically conductive members 40a-n that are separated by a portion of the material generally designated 42 used to construct the one or more mats 12a,b. In the embodiment illustrated in FIGS. 2B and 2C, the plurality of electrically conductive members 40a-n are shown to be a series of conical contacts 44a-n and a series of receptor contracts 46a-n formed with a plurality of conical indentations 48a-n into which the conical contacts 44a-n fit upon application of pressure by a foot 18 of an animal 20. The plurality of electrically conductive members 40a-n shown as a series of conical contacts 44a-n and a series of receptor contacts 46a-n formed with a plurality of conical indentations 48a-n into which the conical contacts 44a-n fit upon application of pressure by a foot 18 of an animal 20 are positioned within a chamber 50a-n formed in the portion of material 42 between opposing pressure-sensing plates 14a-n. Chamber 50a-n permits electrical contact and conductivity when the plurality of electrically conductive members 40a-n is placed in contact by pressure applied to a mat 12a,b by the foot 18 to an animal. As perhaps best shown in FIG. 2C, on application of pressure by a foot 18 to a mats 22a,b, the foot exerts pressure on the plurality of pressure sensing plates 14a-n, causing electrically conductive members between the plates to make contact, which in turn generates and sends one or more signals to the processor 16. The processor 16 is programmed to process a signal either an application of foot pressure to the one or more mats 12a,b or on removal of foot pressure from the one or more mat 12a,b, or both.

In the embodiment illustrated by cross-reference between FIGS. 2C-2D, a plurality of cavities 52a-n is formed during manufacture of mats 12a,b. Plurality of cavities 52a-n may be tubular, as shown by cross-section in FIGS. 2C and 2D, and may be formed to extend along the longitudinal axis of the one or more pressure-sensing plates 14a-n. During manufacture, plurality of cavities 52a-n is formed with a partial vacuum. After manufacture of mats 12a,b, a seal (not shown) is broken, collapsing the partial vacuum, and plurality of cavities 52a-n is substantially filled with a gas. In one non-exclusive example the gas is nitrogen. Nitrogen is, of course, relatively inert, is a constituent of all living tissue, and therefore harmless to an animal 20 if the gas should escape confinement from plurality of cavities 52a-n. As shown in FIG, 2E, when a foot 18 of animal 20 steps on a mat 12a,b, one of the pressure-sensing plates 14b, for example, depresses in the compressibly resilient material. The pressure applied by a foot 18 squeezes the gas-filled cavity, allowing lower side 54a-n of pressure-sensing plate 14b, for example, to make contact with upper side 56a-n of pressure-sensing plate 14n, thus generating a signal that is sent along lead lines 58 to processor 16, as shown in FIG. 2A. When the foot 18 of animal 20 is removed from the mat 12a, pressure-sensing plate 14b returns to its original configuration.

The signals generated by pressure-sensing plates 14a-n, and are sent to processor 16. Processor 16 in turn, activates the array of dispensers 22a-c shown perhaps best in FIG. 3. In the embodiment illustrated in FIG. 3, the array of dispensers 22a-c will be activated by the signals to discharge ingredients 36 on the foot 18 that has activated the array of dispensers 22a-c upon application of approximately twenty-five pounds per square inch by the foot 18.

As perhaps best shown by cross-reference between FIGS. 3-4, the array of dispensers 22a-c includes a housing 60a-c. The housing 60a-c is formed with a plurality of openings 62a-n. The plurality of openings 62a-n is provided to position a plurality of valves (not shown). The plurality of valves is adapted to demountably connect a plurality of emitters 54a-n. The plurality of valves and the plurality of emitters 54a-n are in fluid communication with a set of interconnected tubes 66a-n underlying the platform 24 and the mats 12a,b. The tubes 66a-n are adapted to deliver the ingredients 36 from the tank 34 via the pump 38 to the array of dispensers 22a-c for discharge of the ingredients 36 on the foot 18 of an animal 20.

In the embodiment illustrated in FIGS. 1A-4, the processor 16 is programmable to receive the one or more signals following application of a foot 18 on the one or more mats 12a,b by beginning a first desired time period during which the array of dispensers 22a,c refrains from discharging at least one focused stream of ingredients 32a-n on the foot 18. The processor 16 also is adapted and programmed to process the one or more signals following application of a foot 18 on a mat 12a,b by beginning a second desired time period during which the array of dispensers 22a-c discharges at least one focused stream of ingredients 32a-n on the foot 18. Furthermore, the processor 16 is capable of processing the one or more signals following removal of a foot 18 from a mat 12a,b by beginning a third desired time period during which the array of dispensers 22a-c refrains from discharging at least one focused stream of ingredients 32a-n on the foot 18. In addition, the processor 16 is capable of processing the one or more signals following removal of a foot 18 from a mat 12a,b by beginning a fourth desired time period during which the array of dispensers 22a-c discharges a focused stream of ingredients 32a-n on the foot 18. The delays in discharge of ingredients 36 permit a user to apply specific ingredients to solve a specific problem.

The ability to program the processor 16 also allows an operator of the animal foot spraying system 10 to apply concentrated amounts of ingredients 36 for shorter times but more effectively, while achieving cost effective applications of ingredients 36 for treatment of animal foot problems. For example, on application of foot pressure on the one or more mats 12a,b, a 0.30 second delay may occur, followed by a 0.50-0.70 first spray burst of a focused stream of ingredients 32a-n on the foot 18 of animal 20. Thereafter, as a foot 18 is removed from the one or more mats 12a,b, there may be a 0.15-0.30 second delay as the foot 18 comes is lifted from a mat 12a,b, followed by a discharge of a focused stream of ingredients 32a-n in precise amounts during the time period for about 0.15-0.30 second.

In the embodiment illustrated in FIG. 3, in addition to the array of dispensers 22a-c extending across the platform 24 of the animal foot spraying system 10, one or more spraying turrets 68a-n, is mounted on the proximal outer surface 70a-c of one or more of the array of dispensers 22a-c. The one or more spraying turrets 70a-c is in fluid communication with the tubes 66a-n for discharging ingredients 36 on the foot 18 of an animal 20 and is operatively connected to the processor 16, the tank 34, and the pump 38.

As also best shown in FIG. 3, one or more legs 72a,b is provided. The one or more legs 72a,b are formed with a plurality of sets of variously positioned orifices 74a-n. The one or more sets of variously positioned orifices 74a-n permit an operator of the animal foot treatment system 10 to insert bolts 75a-n or similarly connectors through holes 78a-n in the side flanges 80a,b of the platform 24 and into one or more of the variously positioned orifices 64a-n to adjust the height of the platform 24 relative to variations in the level of the surfaces on which the platform 24 is installed.

As also shown perhaps best in FIG. 3, the one or more housings 50a-c in the array of dispensers 22a-c is formed with a notch 82a-c. The notch 82a-c is provided to allow a mat-flushing device 84, shown diagrammatically in FIG. 3, to periodically emit water through notches 82a-c for flushing the animal foot spraying system 10 of debris. The mat-flushing device 84 is shown diagrammatically in FIG. 3 to include one or more pipes 86a-n connected to a source of water 88 and a timer 90 to repeatedly release a flow of water from the mat-flushing device 84 as and when an operator of the animal foot treatment system 10 desires.

As shown, the animal foot treatment system 10 includes no structural component adapted to enclose the mat or the platform to form a tub or bath for holding one or more ingredients.

Claim elements and steps in this document have been numbered solely as an aid in understanding the description. The numbering is not intended to, and should not be considered as intending to, indicated the ordering of elements and steps in the claims. In addition, the animal foot treatment system shown in drawing FIGS. 1A through 4 shows at least one embodiment that is not intended to be exclusive, but merely illustrative of the disclosed embodiments. Means-plus-function clauses in the claims are intended to cover the structures described as performing the recited function that include not only structural equivalents, but also equivalent structures. Thus, although a nail and screw may not be structural equivalents, a nail and a screw may be equivalent structures.

What is claimed is:

1. An animal foot treatment system, comprising:
a compressively resilient mat,
wherein the compressively resilient mat surroundingly contains a plurality of pressure sensing plates adapted to generate one or more signals to activate the foot treatment system on application of a foot to the mat and on removal of a foot from the mat;
an array of dispenses operatively connected to the plurality of pressure sensing plates and mounted on the compressively resilient mat, adapted to deliver to the foot a focused stream of ingredients;
a processor operatively connected to the plurality of pressure sensing plates and to the array of dispensers,
wherein the processor is adapted to receive and process the one or more signals from the compressively resilient mat to cause the array of dispensers to discharge the focused stream of ingredients in precise amounts during precise time periods; and
a tank in fluid communication with the array of dispensers for holding the ingredients,
wherein the ingredients are delivered from the tank to the array of dispensers by a pump operatively connected to the processor.

2. An animal foot treatment system as recited in claim 1, wherein the plurality of pressure sensing plates is adapted to activate the foot treatment system on application of a foot on the mat or on removal of a foot from the mat.

3. An animal foot treatment system as recited in claim 1, wherein the mat includes no structural component adapted to enclose the mat to form a tub for holding one or more ingredients.

4. An animal foot treatment system as recited in claim 1, wherein the array of dispensers does not dispense a liquid for cleaning either the animal or the foot.

5. An animal foot treatment system as recited in claim 1, further comprising a mat-flushing device positioned adjacent the array of dispensers and operatively connected to the processor, adapted to remove debris from the foot treatment system during operation.

6. An animal foot treatment system as recited in claim 1, wherein the plurality of pressure sensing plates include at least one means for achieving electrical conductivity.

7. An animal foot treatment system as recited in claim 6, wherein the plurality of pressure sensing plates is separated by at least one layer of compressibly resilient material.

8. An animal foot treatment system as recited in claim 1, wherein the array of dispensers includes a housing formed with a plurality of openings in which to position a plurality of valves, and further wherein the plurality of valves is adapted to demountably connect a plurality of emitters.

9. An animal foot treatment system as recited in claim 1, wherein the processor processes the one or more signals following application of a foot on the mat by beginning a first desired time period during which the array of dispensers refrains from discharging that at least one focused stream of ingredients on the foot.

10. An animal foot treatment system as recited in claim 9, wherein the processor processes the one or more signals following application of a foot on the mat by beginning a second desired time period during which the array of dispensers discharges at least one focused stream of ingredients on the foot.

11. An animal foot treatment system as recited in claim 1, wherein the processor processes the one or more signals following removal of a foot from the mat be beginning a third desired time period which the array of dispensers refrains from discharging at least one focused stream of ingredients on the foot.

12. An animal foot treatment system as recited in claim 11, wherein the processor processes the one or more signals following removal of a foot from the mat by beginning a fourth desire time period during which the array of dispensers discharges at least one focused stream of ingredients on the foot.

13. An apparatus for discharging ingredients on a foot, comprising:
at least one dispenser of the ingredients positionable in the path of and beneath an advancing animal;
a tank containing the ingredients in fluid communication with the at least one dispenser;
means operatively connectable to the at least one dispenser and to the tank for activating one or more discharges of ingredients from the tank onto the foot; and
a pressure sensitive mechanism supportingly engaged with the at least one dispenser and operatively connected to the at least one dispense, to the tank, and to the means for activating one or more discharges of ingredients from the tank onto the foot.

14. An appartus for discharging ingredients on a foot as recited in claim 13, wherein the at least on dispenser includes at least one emitter for discharging ingredients onto the foot.

15. An apparatus for discharging ingredients on a foot as recited in claim 14, further comprising a pump operatively connectable to the at least one dispenser and to the means for activating one or more discharges of ingredients for proportionately mixing the ingredients.

16. An apparatus for discharging ingredients on a foot as recited in claim 15, wherein the pressure sensitive mechanism is a compressible mat further comprising means for sensing application of foot pressure on, and release of foot pressure from, the mat.

17. An animal foot sprayer, comprising:
a mat adapted to produce a plurality of signals for a discharging and delaying discharges of ingredients from the foot sprayer in response to application of a foot on the mat and removal of a foot from the mat;
a processor for causing the sprayer to discharge ingredients on the foot; and
means operatively connectable to the mat for determining the amount of ingredients to be discharged during a plurality of desired time intervals.

18. An animal foot sprayer as recited in claim 17, wherein the mat further comprises one or more pressure sensing plates operatively connected to the processor.

19. An animal foot sprayer as recited in claim 16, wherein the means for determining the amount of ingredients to be discharged during a plurality of desired time intervals includes a plurality of dispensers amounted on and operatively connected to the mat, adapted to deliver to the foot a stream of the ingredients.

20. An animal foot sprayer as recited in claim 18, further comprising one or more sources of power for energizing operation of the animal foot sprayer.
